(19) United States
(12) Patent Application Publication
(10) Pub. No.: US 2011/0311430 A1
(43) Pub. Date: Dec. 22, 2011

(54) PROCESS FOR PRODUCTION OF PRECURSOR FIBER FOR PREPARING CARBON FIBER HAVING HIGH STRENGTH AND HIGH ELASTIC MODULUS

(76) Inventors: Yukihiko Abe, Shiga (JP); Hirokazu Nishimura, Shiga (JP); Koichi Hirao, Shiga (JP); Shinsuke Yamaguchi, Shiga (JP); Daisuke Sakura, Shiga (JP); Yoshihiro Watanabe, Okayama (JP); Bunshi Fugetsu, Hokkaido (JP)

(21) Appl. No.: 13/254,290

(22) PCT Filed: Mar. 5, 2010
(86) PCT No.: PCT/JP2010/001545

§ 371 Date: Sep. 1, 2011

(30) Foreign Application Priority Data
Mar. 6, 2009 (JP) 2009-053595
Sep. 29, 2009 (JP) 2009-224215

(51) Int. Cl. D01F 9/12; C08K 7/24; D01D 5/12; C08L 33/20

(52) U.S. Cl. 423/447.2; 524/566; 264/210.1

(57) ABSTRACT

The present invention provides a process for producing a precursor fiber which can provide a carbon fiber having high strength and high elastic modulus. The process of the present invention comprises a step where an aqueous solution of amphoteric molecule is prepared; a step where carbon nanotube is added to the aqueous solution of the amphoteric molecule so that the carbon nanotube is dispersed therein to prepare a dispersion of carbon nanotube; a step where the carbon nanotube dispersion is mixed with a polyacrylonitrile polymer and rhodanate or zinc chloride to prepare a spinning dope; a step where a coagulated yarn is prepared from the spinning dope by a wet or dry-wet spinning method; and a step where the coagulated yarn is drawn to give a precursor fiber for carbon fiber.

### TECHNICAL FIELD OF THE INVENTION

The present invention relates to a process for the production of a precursor fiber for preparing a carbon fiber having high strength and high elastic modulus. The present invention also relates to a precursor fiber produced by such a production process and to a carbon fiber having high strength and high elastic modulus prepared from said precursor fiber. The present invention further relates to a spinning dope which is used for the production of such a precursor fiber.

### BACKGROUND ART

Since a carbon fiber has very good physical properties such as light weight, high strength and high elastic modulus, it has been used as a sporting goods such as fishing rod, golf club or a pair of skis; a formative material such as CNG tank, flywheel, windmill for wind power generation or turbine blade; a reinforcing material for the structure such as road or bridge pier; and a material for aircrafts or space devices and its use has been still expanding.

As a result of expansion of use of the carbon fiber as such, there has been a demand for the development of carbon fiber having much higher strength and elastic modulus.

Carbon fiber is divided broadly into a PAN type carbon fiber where polyacrylonitrile is a material and a pitch type carbon fiber where coal tar derived from carbon and decanted oil, ethylene bottom or the like derived from petroleum is a starting material. Any of those carbon fibers is produced in such a manner that, firstly, a precursor fiber is produced from the material as mentioned above and the resulting precursor fiber is heated at high temperature to subject it to flame-resistance treatment, preliminarily carbonization treatment, and carbonization treatment.

In view of its physical properties, the PAN type carbon fiber which is now being commercially available can achieve the tensile strength of as very high as about 6 GPa at the highest but the tensile elastic modulus can hardly be expressed and is about 300 GPa at the highest. On the other hand, the pitch type carbon fiber which is now being commercially available can achieve the tensile elastic modulus of as very high as about 800 GPa at the highest but the tensile strength can hardly be expressed and is about 3 GPa at the highest. For a purpose of using as aircraft and space device materials, a carbon fiber having high tensile strength and high tensile elastic modulus is desired but, as mentioned above, any of the currently proposed carbon fibers does not satisfy such a requirement.

Incidentally, Patent Document 1 discloses that the precursor fiber prepared by addition of carbon nanotube to the polyacrylonitrile polymer followed by spinning (a PNA type precursor fiber which contains carbon nanotube) shows high tensile elastic modulus than the conventional PAN type precursor fiber.

However, although the precursor fiber prepared by the process of Patent Document 1 is excellent in terms of the tensile elastic modulus, its cross-sectional shape is not circular but is much distorted whereby, unlike the conventional PAN type carbon fiber, the carbon fiber prepared from this precursor fiber does not show high tensile strength. Accordingly, as a result, no carbon fiber where both of the two characteristics of high tensile strength and high tensile elastic modulus are available has been prepared yet.

### PRIOR ART DOCUMENTS

### Patent Documents

Patent Document 1: U.S. Pat. No. 6,852,410

### DISCLOSURE OF THE INVENTION

### Problem that the Invention is to Solve

The present invention has been achieved in view of the above-mentioned current status of the prior art and an object thereof is to provide a precursor fiber which can provide a carbon fiber having high tensile strength and high tensile elastic modulus and also to provide an industrially advantageous process for producing the same.

### Means for Solving the Problem

In order to achieve the above object, the present inventors have conducted an intensive investigation for the improvement in the process of Patent Document 1 and, as a result, they have found that the reason for the great distortion of the cross-sectional shape of the PAN type precursor fiber containing carbon nanotube prepared by the process of Patent Document 1 is the use of dimethylformamide (DMF) as a solvent for the spinning dope and that, when an aqueous solution of rhodanate or zinc chloride is used as a solvent for the spinning dope, there is obtained a PAN type precursor fiber containing carbon nanotube and having substantially circular cross section. It has been however found that, in case an aqueous solution of rhodanate or zinc chloride is used as a solvent instead of DMF, the carbon nanotube is apt to be immediately aggregated and separated when a dispersion of carbon nanotube is added to the spinning dope, that blocks of aggregated and separated matter are scattered in the resulting coagulated yarn whereby breakage of the yarn starting from the blocks is apt to be resulted during drawing and no sufficient drawing can be done and accordingly that the orientation of polymer chain and carbon nanotube are insufficient in the precursor fiber whereby the high tensile strength and tensile elastic modulus which are inherently expected by addition of the carbon nanotube cannot be expressed. It has been further found that, when the carbon nanotube is abundantly aggregated and separated in the spinning dope, spinning ability of the spinning dope is lost or clogging of the filter of the spinning nozzle is resulted whereby the spinning becomes impossible. In view of the above, the present inventors have further investigated for a process where an aqueous solution of rhodanate or zinc chloride is still used as a solvent for the spinning dope while separation of carbon nanotube in the spinning dope can be suppressed and they have found that, when an amphoteric molecule is jointly used as a dispersing agent during addition of carbon nanotube, the carbon nanotube is stably dispersed in the solvent and is hardly aggregated and separated. They have further found that the amphoteric molecule contained in the spinning dope is extracted into a coagulating bath during spinning and scarcely remains in the yarn whereby an effect of improving the physical properties of the yarn by addition of carbon nanotube is higher. Based on these findings, they have accomplished the present invention.

Thus, in accordance with the present invention, there is provided a process for the production of a precursor fiber for carbon fiber, which is characterized in comprising the following steps (1) to (5):

(1) a step where an aqueous solution of amphoteric molecule is prepared;

(2) a step where carbon nanotube is added to the aqueous solution of the amphoteric molecule so that the carbon nanotube is dispersed therein to prepare a dispersion of carbon nanotube;

(3) a step where the carbon nanotube dispersion is mixed with a polyacrylonitrile polymer and rhodanate or zinc chloride to prepare a spinning dope;

(4) a step where a coagulated yarn is prepared from the spinning dope by a wet or dry-wet spinning method; and

(5) a step where the coagulated yarn is drawn to give a precursor fiber for carbon fiber.

In a preferred embodiment of the producing process according to the present invention, the spinning dope prepared in the step (3) contains 30 to 60% by weight of rhodanate, 5 to 30% by weight of polyacrylonitrile polymer, 0.01 to 5% by weight of carbon nanotube to the polyacrylonitrile polymer, and 0.01 to 5.0% by weight of amphoteric molecule.

In a preferred embodiment of the producing process according to the present invention, the spinning dope prepared in the step (3) contains 30 to 70% by weight of zinc chloride, 5 to 30% by weight of polyacrylonitrile polymer, 0.01 to 5% by weight of carbon nanotube to the polyacrylonitrile polymer, and 0.01 to 5.0% by weight of amphoteric molecule.

In a preferred embodiment of the producing process according to the present invention, before carbon nanotube is dispersed in the step (2), a wetting treatment is carried out and, further, the carbon nanotube dispersion is subjected to a stabilization treatment.

Further, in accordance with the present invention, there is provided a precursor fiber for carbon fiber produced by the above process, which is characterized in having substantially circular cross section and containing carbon nanotube.

Still further, in accordance with the present invention, there is provided a precursor fiber for carbon fiber, which is characterized in having substantially circular cross section and containing carbon nanotube.

Furthermore, in accordance with the present invention, there is provided a carbon fiber produced by subjecting the above precursor fiber to flame-resistance treatment, preliminarily carbonization treatment, and carbonization treatment, which is characterized in that, the carbon fiber has high tensile strength and high tensile elastic modulus.

Still furthermore, in accordance with the present invention, there is provided a spinning dope which is characterized in comprising an aqueous solution containing rhodanate or zinc chloride, polyacrylonitrile polymer, carbon nanotube and amphoteric molecule.

### Advantages of the Invention

Since an aqueous solution of rhodanate or zinc chloride is used as a solvent for a spinning dope in the process for producing a PAN-type precursor fiber containing carbon nanotube according to the present invention, it is now possible to prepare a precursor fiber having substantially circular cross section. Further, since the amphoteric molecule acting as a dispersing agent suppresses aggregation and separation of carbon nanotube from the spinning dope and further since the amphoteric molecule is extracted into a coagulating bath during the spinning and does not remain in the yarn, the resulting yarn does not contain blocks of aggregated/separated thing and can be fully drawn so as to orient the polymer chain and the carbon nanotube. Accordingly, the carbon fiber prepared from such a precursor fiber has a high tensile elastic modulus in addition to a high tensile strength which is the characteristic of the PAN type carbon fiber caused by containment of the appropriately oriented carbon nanotube and by orientation of high-molecular chain. Furthermore, unlike a dispersing agent which has been commonly used for dispersing the carbon nanotube, it is not necessary to conduct ultrasonic irradiation and centrifugal separation when dispersing the carbon nanotube whereby the process of the present invention is quite suitable for the production in an industrial scale.

### BRIEF DESCRIPTION OF THE DRAWINGS

FIG. 1 is a cross-sectional photographic picture of the precursor fiber obtained in Example 1A.

FIG. 2 is a cross-sectional photographic picture of the precursor fiber obtained in Comparative Example 2A.

### BEST MODE FOR CARRYING OUT THE INVENTION

As hereunder, a process for producing the precursor fiber for a PAN-type carbon fiber containing carbon nanotube according to the present invention will be illustrated in detail.

In the producing process of the present invention, an aqueous solution of amphoteric molecule is firstly prepared (step (1)).

The amphoteric molecule used in the present invention is a molecule having a group comprising positive electric charge and a group comprising negative electric charge in a molecule and each group forms a salt with counterion. Specific examples thereof include 3-(N,N-dimethylstearylammonio)propane sulfonate, 3-(N,N-dimethylmyristylammonio)propane sulfonate, 3-[(3-cholamidopropyl)dimethylammonio]-1-propane sulfonate, 3-[(3-cholamidopropyl)dimethylammonio]-2-hydroxypropane sulfonate, n-dodecyl-N,N′-dimethyl-3-ammonio-1-propane sulfonate, n-hexadecyl-N,N′-dimethyl-3-ammonio-1-propane sulfonate, n-octylphosphocholine, n-dodecylphosphocholine, n-tetradecylphosphocholine, n-hexadecylphosphocholine, dimethylalkylbetaine, perfluoroalkylbetaine, lecithin, 2-methacryloyloxyethylphosphoryl choline and polymers and polypeptides thereof. As to the amphoteric molecule, one of the above ones may be used solely or two or more thereof may be used by mixing and, further, it/they may be used together with cationic surfactant, anionic surfactant or neutral surfactant.

Preparation of an Aqueous Solution of the amphoteric molecule can be easily carried out by adding the amphoteric molecule to water followed by stirring at room temperature. Concentration of the amphoteric molecule is preferred to be 0.01 to 5.0% by weight and more preferred to be 0.1 to 2.0% by weight. When it is less than the above lower limit, there may be the case where the effect of a dispersing agent for carbon nanotube cannot be fully achieved. When it is more than the above upper limit, there is also the case where the effect of a dispersing agent for carbon nanotube cannot be fully achieved.

After that, carbon nanotube is added to the aqueous solution of the amphoteric molecule to disperse the carbon nanotube whereupon a carbon nanotube dispersion is prepared (step (2)).

The carbon nanotube used in the present invention may be any of single-wall carbon nanotube, double-wall carbon nanotube, multi-wall carbon nanotube and a mixture thereof. The terminal of such a carbon nanotube may be closed or open. Diameter of the carbon nanotube is preferred to be 0.4 nm to 100 nm and more preferred to be 0.8 nm to 80 nm. Although the length of the carbon nanotube is not limited but any length may be used, it is preferred to be 0.6 μm to 200 μm.

Purity of the carbon nanotube used in the present invention is preferred to be not less than 80%, more preferred to be not less than 90%, and more preferred to be not less than 95%, in terms of carbon purity. The carbon purity is determined by means of differential thermal analysis. Examples of the impurity of the carbon nanotube include noncrystalline carbon component and catalytic metal. The noncrystalline carbon component can be removed by heating at not lower than 200° C. in air or by washing with an aqueous solution of hydrogen peroxide. Further, the catalytic metal incorporated during the manufacture of carbon nanotube such as iron can be removed by washing with mineral acid such as hydrochloric acid, nitric acid or sulfuric acid followed by washing with water. It is preferred in the present invention to use carbon nanotube wherefrom various impurities are removed by combining those purifying operations so as to enhance the carbon purity.

Adding amount of the carbon nanotube is preferred to be 0.01 to 5% by weight and more preferred to be 0.1 to 3% by weight to the amount of the polyacrylonitrile polymer which is to be mixed in the next step (3). When the amount is less than the above lower limit, the amount of the carbon nanotube in the resulting precursor fiber is small whereby there may be a risk that the sufficiently high tensile elastic modulus cannot be achieved. When it is more than the above upper limit, spinning ability is not available in the spinning dope whereby the spinning is difficult.

Dispersing of the carbon nanotube is necessary for loosening the bundled carbon nanotube and, although the dispersing is available in the case of using amphoteric molecule provided that slow stirring was conducted, it is still better to disperse by applying the physical force for a purpose of industrially conducting a dispersing treatment with high efficiency and without non-uniformity. Examples of the means for the dispersing include the dispersing using ball mill, beads mill and plural (three or more) rolls. When the dispersion turns black and transparent upon checking by naked eye, the carbon nanotube is sufficiently dispersed.

In order to efficiently conduct the dispersing of the carbon nanotube within short time, it is preferred that, before the dispersing, a wetting treatment is carried out. Here, the term reading “wetting treatment” is a treatment where amphoteric molecule which is a dispersing agent is permeated among the bundled carbon nanotube so as to give a cause for the dispersing of the carbon nanotube. Usually, when amphoteric molecule is used, mere application of slow stirring gradually results in the dispersing of the carbon nanotube by means of electrostatic force. However, in the case where the dispersing within short time in an industrially big scale is needed, permeation of the amphoteric molecule among the carbon nanotubes by physical means can finish the dispersing within short time without non-uniformity. An example of such a physical means is that heat is applied to a system wherein the carbon nanotube is present in an autoclave so as to make the bundles of the carbon nanotube swollen and then pressure is applied thereto. At that time, the temperature range is 50 to 150° C., more preferably 80 to 150° C., and the pressure range is 1.1 to 2.0 atmospheres.

After preparing the carbon nanotube dispersion, it is preferred to conduct a stabilizing treatment where a stabilizer is added to the dispersion for enhancing the stability of the dispersion. The stabilizing treatment is necessary for preventing the re-aggregation of the dispersed carbon nanotube and it has an effect of preventing the changes with elapse of time when the carbon nanotube dispersion is not immediately used. Examples of the stabilizer include polyhydric alcohol such as glycerol or ethylene glycol; polyvinyl alcohol; polyoxyethylene compound such as polyoxyethylenized fatty acid or ester derivative thereof; polysaccharide such as water-soluble cellulose, water-soluble starch, water-soluble glycogen or derivative thereof such as cellulose acetate or amylopectin; amine compound such as alkylamine. Each of those stabilizers may be used solely or two or more thereof may be used jointly. Adding amount of the stabilizer is preferred to be 0.006 to 3% by weight and more preferred to be 0.06 to 1.2% by weight to the amount of the carbon nanotube dispersion.

After that, this carbon nanotube dispersion is mixed with the polyacrylonitrile polymer and rhodanate or zinc chloride to prepare a spinning dope (step (3)).

In this mixing, the polyacrylonitrile polymer and rhodanate or zinc chloride may be added to the carbon nanotube dispersion or, alternatively, a polymer solution where the polyacrylonitrile polymer is dissolved in an aqueous solution of rhodanate or zinc chloride may be mixed with a carbon nanotube dispersion. In the former case, addition of the polyacrylonitrile polymer and rhodanate or zinc chloride may be done at the same time or any of them may be added firstly. It is not necessary that the addition is done at a time but may be done dividedly. When the polyacrylonitrile polymer is added, it is preferred to make into the state of aqueous slurry by addition of water if necessary. In that case, it is also possible that the water to be added is previously made abundant and, later, the water is gradually evaporated under ordinal pressure or in vacuo to adjust the viscosity of the spinning dope.

As to the polyacrylonitrile polymer used in the present invention, it is possible to use polyacrylonitrile and a copolymer comprising acrylonitrile and copolymerizable vinyl monomer. Examples of the copolymer include a copolymer of acrylonitrile with methacrylic acid, a copolymer of acrylonitrile with methyl methacrylate, a copolymer of acrylonitrile with acrylic acid, a copolymer of acrylonitrile with itaconic acid, a copolymer of acrylonitrile with methacrylic acid and itaconic acid, a copolymer of acrylonitrile with methyl methacrylate and itaconic acid and a copolymer of acrylonitrile with acrylic acid and itaconic acid having an effective action for an flame-resisting reaction. In any of the above cases, it is preferred that the acrylonitrile component is not less than 85 molar %. Those polymers may form a salt with alkali metal or ammonia. One of those polymers may be used solely or two or more thereof may be used as a mixture.

Adding amount of the polyacrylonitrile polymer is preferred to be 5 to 30% by weight and more preferred to be 10 to 20% by weight in the spinning dope. When the amount is less than the above lower limit, it is not possible to apply the spinning tension whereupon orientation of the carbon nanotube in the fiber itself and in the yarn is insufficient and there may be a risk of causing the insufficient strength. When it is more than the above upper limit, there is a risk of causing a rise in the back pressure during spinning.

The rhodanate which can be used in the present invention may be anything so far as it is a salt of thiocyanic acid with univalent or divalent metal and the particularly preferred ones are sodium thiocyanate and potassium thiocyanate. It is also possible to use a mixture thereof. Since a rhodanate is very hardly soluble, it is preferred that addition of the rhodanate is conducted together with vigorous stirring of the dispersion. If necessary, the dispersion may be heated at about 30° C. to about 90° C. so that the rhodanate is completely dissolved.

Adding amount of the rhodanate is preferred to be 30 to 60% by weight and more preferred to be 40 to 55% by weight in the spinning dope. When the amount is less that the above lower limit, there may be a risk that the polyacrylonitrile polymer cannot be dissolved. When the amount is more than the above upper limit, there may be a risk that the rhodanate is separated or that the carbon nanotube which was once dispersed is aggregated and separated.

The aqueous solution of zinc chloride which can be used in the present invention is an aqueous solution of sole zinc chloride or a mixed salt thereof with a chloride of sodium, potassium, magnesium, etc. The amount of zinc chloride used is preferred to be 30 to 70% by weight, more preferred to be 50 to 70% by weight and further preferred to be 56 to 65% by weight in the spinning dope. When the amount is less than the above lower limit, there may be a risk that the polyacrylonitrile polymer cannot be dissolved. When the amount is more than the above upper limit, there may be a risk that zinc chloride is separated or that the carbon nanotube which was once dispersed is aggregated and separated. It is preferred that the aqueous solution of zinc chloride does not contain zinc oxide.

The spinning dope prepared by the above step (3) comprises an aqueous solution containing rhodanate or zinc chloride, polyacrylonitrile polymer, carbon nanotube and amphoteric molecule. In this aqueous solution, carbon nanotube is stably dispersed in water due to the dispersing action of the amphoteric molecule and, even if any impact is applied, it is hardly separated.

When rhodanate is used, viscosity of the spinning dope of the present invention is usually preferred to be 2 to 20 Pa·sec at 30° C. in the case of a wet spinning while, in the case of a dry-wet spinning, it is preferred to be 100 to 500 Pa·sec. When zinc chloride is used, viscosity of the spinning dope of the present invention is usually preferred to be 5 to 50 Pa·sec at 30° C. in the case of a wet spinning while, in the case of a dry-wet spinning, it is usually preferred to be 30 to 300 Pa·sec. In case of lower than the above range in each of the spinning methods, there may be a risk that the spinning dope sticks to the nozzle surface during spinning or there is a problem of breakage of the discharged yarn or non-uniform quality while, in case of more than the above range, there is a risk of causing the problem in operability of spinning such as that melt fracture is generated whereby no stable spinning is possible.

After that, a coagulated yarn is prepared from this spinning dope by a wet or a dry-wet spinning method (step (4)).

The pore diameter of the spinning nozzle is preferred to be 0.03 to 0.1 mm in the wet spinning while, in the dry-wet spinning, it is preferred to be 0.1 to 0.3 mm. When the diameter is less than the above range, there is risk that the draft ratio during spinning becomes small whereby the productivity is greatly deteriorated or there is a problem such as breakage of the discharged yarn or non-uniform quality while, when the diameter is more than the above range, there may be a risk of causing the problem in operability of the spinning such as that the discharging linear speed of the spinning dope becomes small whereby tension of the yarn in the coagulating bath becomes high.

As to the coagulating bath, it is preferred to use water, an aqueous solution of Lewis acid salt such as zinc chloride or aluminum chloride, an aqueous solution of rhodanate or an aqueous solution of zinc chloride. Concentration of Lewis acid salt, rhodanate or zinc chloride is preferred to be 10 to 30% by weight and the temperature is preferred to be kept at −5 to 10° C. When the concentration of Lewis acid salt, rhodanate or zinc chloride is lower than 10% by weight, there may be a risk that the coagulation quickly proceeds from the surface of the discharged spinning dope and the coagulation of the central area of the fiber becomes insufficient whereby formation of uniform yarn structure is not conducted. When the concentration is higher than 30% by weight, there may be a risk that the coagulation is slow whereby the adjacent yarns stick each other during the step until the winding. The coagulation is preferred to be conducted in multiple stages and, particularly preferably, it is conducted in two to three stages. When the coagulation is done in one stage, there may be a risk that coagulation until the central area of the yarn is insufficient whereby formation of uniform yarn structure is not possible. When it is done in four or more stages, production facility becomes massive and that is not practical.

The pulling speed during spinning is preferred to be within a range of 3 to 20 m/minute. When it is less than 3 m/minute, there may be a risk that productivity becomes very low. On the other hand, when it is more than 20 m/minute, there may be a risk that breakage of the yarn near the spinning nozzle frequently happens whereby the operability is greatly deteriorated.

After that, the coagulated yarn prepared in the step (4) is drawn to give a precursor fiber of the carbon fiber (step (5)). As a result of the drawing, orientation of the molecular chain in the fiber is enhanced whereby a carbon fiber having an excellent mechanical physical property can be prepared. The drawing is conducted preferably to make the drawing rate 4 to 12 fold and, more preferably, to make the drawing rate 5 to 7 fold. When the total drawing rate is less than the above lower limit, there may be a risk that orientation of the carbon nanotube in the yarn becomes insufficient whereby it is not possible to prepare a carbon fiber precursor in which the polyacrylonitrile polymer is tightly oriented. When the total drawing rate is more than the above upper limit, there may be a risk that breakage of the yarn frequently happens during the drawing whereby the stability of the drawing is lacking. The drawing operation may be done by any of the methods such as drawing under cooling, drawing in hot water and drawing in steam. The drawing may be conducted at a time or in multiple stages.

The precursor fiber prepared by the above steps (1) to (5) has substantially circular shape necessary for achieving the high tensile strength and further contains carbon nanotube resulting in a high tensile elastic modulus in an appropriate orientation. Accordingly, when this precursor fiber is subjected to flame resistance treatment, preliminary carbonization treatment, and carbonization treatment, a carbon fiber having very high tensile strength and tensile elastic modulus can be prepared.

In the present invention, the flame resistance treatment, preliminary carbonization treatment, and carbonization treatment of the precursor fiber may be performed in accordance with a conventional method. Thus, for example, the precursor fiber is firstly subjected to a flame resistance treatment by heating at 200 to 300° C. together with drawing in air at the drawing ratio of 0.8 to 2.5, then subjected to a preliminary carbonization treatment by heating at 300 to 800° C. together with drawing in inert gas at the drawing ratio of 0.9 to 1.5 and further subjected to a carbonization treatment by heating at 1000 to 2000° C. together drawing in inert gas at the drawing ratio of 0.9 to 1.1 whereupon the carbon fiber can be prepared.

Examples of the inert gas used during the preliminary carbonization treatment and the carbonization treatment include nitrogen, argon, xenon and carbon dioxide. From the economical viewpoint, it is preferred to use nitrogen. The highest reaching temperature during the carbonization treatment is set at between 1200 and 3000° C. depending upon the desired mechanical physical property of the carbon fiber. It is general that the higher the maximum reaching temperature for the carbonization treatment, the more the tensile elastic modulus of the resulting carbon fiber. On the other hand, the tensile strength becomes highest at 1500° C. In the present invention, the carbonization treatment is conducted at 1000 to 2000° C., preferably at 1200 to 1700° C. and more preferably at 1300 to 1600° C. whereby it is now possible that the two mechanical physical properties of tensile elastic modulus and tensile strength are expressed at the highest.

### EXAMPLES

As hereunder, the present invention will be more specifically illustrated by way of the following Examples although the present invention is not limited by those Examples.

Incidentally, tensile strength and tensile elastic modulus of the carbon fibers prepared by those Examples were measured using “TG 200 NB” which is a tensile test machine manufactured by NMB and according to the “Test Method for Tensile Characteristics of Carbon Fiber-Single Fiber” stipulated in JIS R7606 (2000).

### Example 1A

Preparation of spinning dope: To 1000 ml of water was added 5 g of 3-(N,N-dimethylmyristylammonio) propane sulfonate as amphoteric molecule followed by stirring at room temperature for 5 minutes. To this was added 5 g of double-wall carbon nanotube (grade XO manufactured by Unidym) and the mixture was subjected to a wetting treatment at 130° C. and 1.5 atmospheres for about 2 hours using an autoclave (HICLAVE HG-50 manufactured by Hirayama). After cooling down to room temperature, the above was stirred for about 90 minutes at 40 Hz using a beads mill (Dyno-mill, manufactured in Switzerland, zirconium beads, diameter: 0.65 mm) whereupon carbon nanotube was dispersed in an aqueous solution of amphoteric molecule. To this was further added 3 g of polyoxyethylene alkyl lauryl ether sulfonate followed by slowly stirring for about 5 minutes to conduct a stabilizing treatment whereupon a carbon nanotube dispersion was prepared. The above carbon nanotube dispersion (30.7 g), 20 g of an AN94-MAA6 copolymer containing 25% of water and 17.7 ml of water were measured and placed into a 500-ml separable flask equipped with a Logborn blade and stirred to make into a slurry form. Sodium thiocyanate (44.2 g) was added thereto during 2 hours with stirring. After stirring the above for 1 hour at room temperature, 12.2 g of water was evaporated therefrom in vacuo by heating the bath temperature up to 90° C. at the highest to give a spinning dope. The composition of the resulting spinning dope is shown in Table 1.

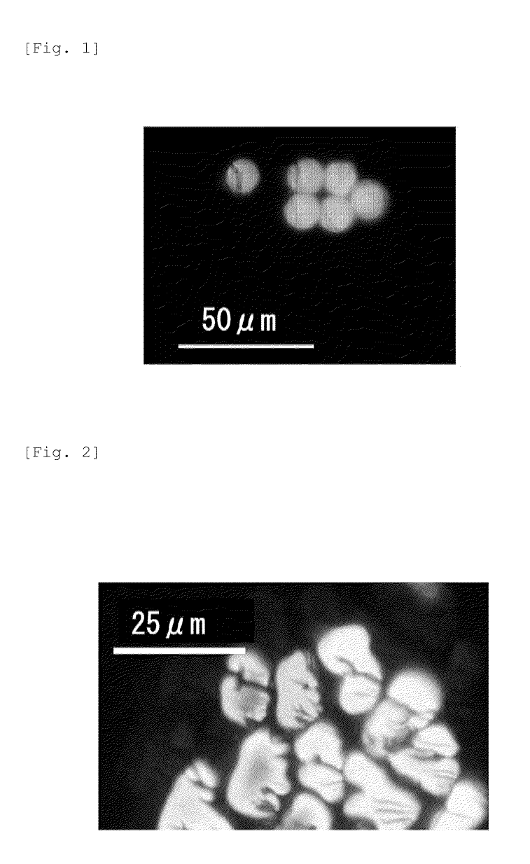

Spinning: The above spinning dope was extruded at 80° C. from a spinning nozzle where the pore size was 0.15 mm and the pore numbers were 10, then introduced into a coagulating bath comprising 15 liters of a 15% by weight aqueous solution of sodium thiocyanate at 0° C. via air gap of 5 mm and washed with a 5% by weight aqueous solution of sodium thiocyanate. After that, it was drawn to an extent of two-fold, washed with water and further washed with 0.2% by weight of nitric acid. Then this yarn was further drawn in three-fold in boiling water and an amino-modified silicone oil was applied thereto followed by drying at 150° C. for 5 minutes to give a precursor fiber where a single yarn fineness was 1.3 dTex. Shape of cross section of this fiber is shown in FIG. 1. As will be apparent from FIG. 1, there was prepared a precursor fiber having substantially circular cross section.

Flame-resistance treatment: The above precursor fiber was heated in air for 1 hour each in a constant length at 220° C., 230° C., 240° C. and 250° C. in the first, second, third and fourth stages, respectively to give the yarn of 1.38 specific gravity being subjected to a flame-resistance treatment.

Preliminary carbonization treatment: The above yarn subjected to the flame-resistance treatment was heated in nitrogen stream for 2 minutes in a constant length at 700° C. to give the yarn being subjected to a preliminary carbonization treatment.

Carbonization treatment: The above yarn subjected to the preliminary carbonization treatment was heated in nitrogen stream for 2 minutes in a constant length at 1300° C. to give a carbon fiber. Tensile strength and tensile elastic modulus of the resulting carbon fiber are shown in Table 2.

### Example 2A

The same operation as in Example 1A was conducted using a single-wall carbon nanotube (Hipco manufactured by CNI) instead of the double-wall carbon nanotube to prepare a spinning dope. Composition of the resulting spinning dope is shown in Table 1. This was further stirred for 3 hours using a mixer of a rotation/revolution type to give the final spinning dope. Spinning, preliminary carbonization treatment and carbonization treatment were carried out according to the same manner as in Example 1A to give a carbon fiber. Tensile strength and tensile elastic modulus of the resulting carbon fiber are shown in Table 2. The cross-sectional shape of the precursor fiber was confirmed and found to be substantially circular cross section the same as in Example 1A.

### Example 3A

The same operation as in Example 1A was conducted except for using a multi-wall carbon nanotube (Baytubes manufactured by Bayer MaterialScience AG) instead of the double-wall carbon nanotube in Example 1A to prepare a spinning dope. Composition of the resulting spinning dope is shown in Table 1. Using this spinning dope, a carbon fiber was obtained in the same manner as in Example 1A. Tensile strength and tensile elastic modulus of the resulting carbon fiber are shown in Table 2. The cross-sectional shape of the precursor fiber was confirmed and found to be substantially circular cross section the same as in Example 1A.

### Example 4A

The same operation as in Example 1A was conducted except for using a AN95-MA5 copolymer instead of the AN94-MAA6 copolymer in Example 1A to prepare a spinning dope. Composition of the resulting spinning dope is shown in Table 1. Using this spinning dope, a carbon fiber was obtained in the same manner as in Example 1A. Tensile strength and tensile elastic modulus of the resulting carbon fiber are shown in Table 2. The cross-sectional shape of the precursor fiber was confirmed and found to be substantially circular cross section the same as in Example 1A.

### Example 5A

The same operation as in Example 3A was conducted except for using a AN95-MAA4-IA1 copolymer instead of the AN94-MAA6 copolymer in Example 3A to prepare a spinning dope. Composition of the resulting spinning dope is shown in Table 1. Using this spinning dope, a carbon fiber was obtained in the same manner as in Example 3A. Tensile strength and tensile elastic modulus of the resulting carbon fiber are shown in Table 2. The cross-sectional shape of the precursor fiber was confirmed and found to be substantially circular cross section the same as in Example 1A.

### Example 6A

The same operation as in Example 1A was conducted except for using a PAN instead of the AN94-MAA6 copolymer in Example 1A to prepare a spinning dope. Composition of the resulting spinning dope is shown in Table 1. Using this spinning dope, a carbon fiber was obtained in the same manner as in Example 1A. Tensile strength and tensile elastic modulus of the resulting carbon fiber are shown in Table 2. The cross-sectional shape of the precursor fiber was confirmed and found to be substantially circular cross section the same as in Example 1A.

### Example 7A

The same operation as in Example 6A was conducted except for preparing a spinning dope by using a single-wall carbon nanotube instead of the double-wall carbon nanotube in Example 6A and stirring for 3 hours using a mixer of a rotation/revolution type as in Example 2A to prepare a spinning dope. Composition of the resulting spinning dope is shown in Table 1. Using this spinning dope, a carbon fiber was obtained in the same manner as in Example 6A. Tensile strength and tensile elastic modulus of the resulting carbon fiber are shown in Table 2. The cross-sectional shape of the precursor fiber was confirmed and found to be substantially circular cross section the same as in Example 1A.

### Example 8A

The same operation as in Example 4A was conducted except for using a multi-wall carbon nanotube instead of the double-wall carbon nanotube in Example 4A to prepare a spinning dope. Composition of the resulting spinning dope is shown in Table 1. Using this spinning dope, a carbon fiber was obtained in the same manner as in Example 4A. Tensile strength and tensile elastic modulus of the resulting carbon fiber are shown in Table 2. The cross-sectional shape of the precursor fiber was confirmed and found to be substantially circular cross section the same as in Example 1A.

### Example 9A

The same operation as in Example 1A was conducted except for using 1.0 g of double-wall carbon nanotube in Example 1A to prepare a spinning dope. Composition of the resulting spinning dope is shown in Table 1. Using this spinning dope, a carbon fiber was obtained in the same manner as in Example 1A. Tensile strength and tensile elastic modulus of the resulting carbon fiber are shown in Table 2. The cross-sectional shape of the precursor fiber was confirmed and found to be substantially circular cross section the same as in Example 1A.

### Example 10A

The same operation as in Example 3A was conducted except for using 5 g of 3-(N,N-dimethylstearylammonio)propane sulfonate as an amphoteric molecule in Example 3A to prepare a spinning dope. Composition of the resulting spinning dope is shown in Table 1. Using this spinning dope, a carbon fiber was obtained in the same manner as in Example 3A. Tensile strength and tensile elastic modulus of the resulting carbon fiber are shown in Table 2. The cross-sectional shape of the precursor fiber was confirmed and found to be substantially circular cross section the same as in Example 1A.

### Example 11A

The same operation as in Example 1A was conducted except for using 5 g of 3-[(3-cholamidopropyl)dimethylammonio]-1-propane sulfonate as an amphoteric molecule in Example 1A to prepare a spinning dope. Composition of the resulting spinning dope is shown in Table 1. Using this spinning dope, a carbon fiber was obtained in the same manner as in Example 1A. Tensile strength and tensile elastic modulus of the resulting carbon fiber are shown in Table 2. The cross-sectional shape of the precursor fiber was confirmed and found to be substantially circular cross section the same as in Example 1A.

### Example 12A

To 45.5 ml of water was added 3 g of 3-(N,N-dimethylmyristylammonio)propane sulfonate as amphoteric molecule followed by stirring at room temperature for 5 minutes. To this was added 3 g of multi-wall carbon nanotube (Baytubes manufactured by Bayer MaterialScience AG) and the mixture was subjected to a wetting treatment at 130° C. and 1.5 atmospheres for about 2 hours in an autoclave. After cooling down to room temperature, the above was stirred for about 90 minutes at 40 Hz using a beads mill whereupon carbon nanotube was dispersed in an aqueous solution of amphoteric molecule. To this was further added 1 g of polyoxyethylene alkyl lauryl ether sulfonate followed by slowly stirring for about 5 minutes to conduct a stabilizing treatment. To this was added 45.5 g of sodium thiocyanate followed by stirring to dissolve whereupon a carbon nanotube dispersion was prepared. The above carbon nanotube dispersion (5.05 g), 20 g of an AN94-MAA6 copolymer containing 25% of water and 45.6 ml of water were measured and placed into a 500-ml eggplant type flask followed by stirring to make into a slurry form. After it was stirred for 2 hours at room temperature, 12.2 g of water was evaporated therefrom using an evaporator to give a spinning dope. Composition of the resulting spinning dope is shown in Table 1. Using this spinning dope, a carbon fiber was obtained in the same manner as in Example 1A. Tensile strength and tensile elastic modulus of the resulting carbon fiber are shown in Table 2. The cross-sectional shape of the precursor fiber was confirmed and found to be substantially circular cross section the same as in Example 1A.

### Example 13A

An AN94-MAA6 copolymer (15 g), 50.6 ml of water and 41.8 g of sodium thiocyanate were measured and placed into a 500-ml eggplant type flask, stirred at 60 to 80° C. for 10 minutes and gradually cooled down to room temperature to give a polymer solution. To this was added 5.05 g of the carbon nanotube dispersion prepared in Example 12A, the mixture was stirred at room temperature for 2 hours and 12.2 g of water was evaporated therefrom using an evaporator to give a spinning dope. Composition of the resulting spinning dope is shown in Table 1. Using this spinning dope, a carbon fiber was obtained in the same manner as in Example 1A. Tensile strength and tensile elastic modulus of the resulting carbon fiber are shown in Table 2. The cross-sectional shape of the precursor fiber was confirmed and found to be substantially circular cross section the same as in Example 1A.

### Example 14A

To 93 ml of water was added 3 g of 3-(N,N-dimethylmyristylammonio)propane sulfonate as amphoteric molecule followed by stirring at room temperature for 5 minutes. To this was added 3 g of multi-wall carbon nanotube (Baytubes manufactured by Bayer MaterialScience AG) and the mixture was subjected to a wetting treatment at 130° C. and 1.5 atmospheres for about 2 hours in an autoclave. After cooling down to room temperature, the above was stirred for about 90 minutes at 40 Hz using a beads mill whereupon carbon nanotube was dispersed in an aqueous solution of amphoteric molecule. To this was further added 1 g of polyoxyethylene alkyl lauryl ether sulfonate followed by slowly stirring for about 5 minutes to conduct a stabilizing treatment whereupon a multi-wall carbon nanotube dispersion was prepared. On the other hand, 15 g of an AN94-MAA6 copolymer, 36.15 ml of water and 44.2 g of sodium thiocyanate were measured and placed into a 500-ml eggplant type flask followed by stirring to give a suspension. To this suspension was added 5 g of the above carbon nanotube dispersion and the mixture was stirred at 80° C. for 10 minutes and gradually cooled down to room temperature to give a spinning dope. Composition of the resulting spinning dope is shown in Table 1. Using this spinning dope, a carbon fiber was obtained in the same manner as in Example 1A. Tensile strength and tensile elastic modulus of the resulting carbon fiber are shown in Table 2. The cross-sectional shape of the precursor fiber was confirmed and found to be substantially circular cross section the same as in Example 1A.

### Example 15A

To 1000 ml of water was added 5 g of 3-[(3-cholamidopropyl)dimethylammonio]-1-propane sulfonate as amphoteric molecule followed by stirring at room temperature for 5 minutes. To this was added 5 g of single-wall carbon nanotube (Hipco manufactured by CNI) and the mixture was subjected to a wetting treatment at 130° C. and 1.5 atmospheres for about 2 hours in an autoclave. After cooling down to room temperature, the above was stirred for about 90 minutes at 40 Hz using a beads mill (zirconium beads, diameter: 0.65 mm) whereupon carbon nanotube was dispersed in an aqueous solution of amphoteric molecule. To this was further added 1 g of ethylene glycol followed by slowly stirring for about 5 minutes to conduct a stabilizing treatment whereupon a carbon nanotube dispersion was prepared. The above carbon nanotube dispersion (30.7 g) and 17.7 ml of water were measured and placed into a 500-ml eggplant type flask and 44.2 g of potassium thiocyanate was added thereto with stirring during 1 hour. After 20 g of an AN94-MAA6 copolymer containing 25% of water was added thereto with stirring at room temperature, the mixture was stirred at room temperature for 1 hour. After that, 12.2 g of water was evaporated therefrom using an evaporator to give a spinning dope. Composition of the resulting spinning dope is shown in Table 1. Using this spinning dope, a carbon fiber was obtained in the same manner as in Example 1A. Tensile strength and tensile elastic modulus of the resulting carbon fiber are shown in Table 2. The cross-sectional shape of the precursor fiber was confirmed and found to be substantially circular cross section the same as in Example 1A.

### Comparative Example 1A

Water (39.2 ml) and 20 g of an AN94-MAA6 copolymer containing 25% of water were measured and placed into a 500-ml eggplant type flask and the mixture was stirred to make into a slurry form. Sodium thiocyanate (44.2 g) was added thereto with stirring during 2 hours. After the mixture was stirred for 1 hour at room temperature, it was heated up to 60° C. to give a uniform spinning dope. Using this spinning dope, a carbon fiber was obtained in the same manner as in Example 1A. Tensile strength and tensile elastic modulus of the resulting carbon fiber are shown in Table 2. The cross-sectional shape of the precursor fiber was confirmed and found to be substantially circular cross section the same as in Example 1A.

### Comparative Example 2A

Preparation of spinning dope: To 600 ml of dimethylformamide was added 0.025 g of double-wall carbon nanotube (grade XO manufactured by Unidym) and the mixture was irradiated with ultrasonic wave of 42 kHz and 100 W using an ultrasonic wave device (Branson 3510R MT) for 36 hours. This dispersion was prepared in six in total. In a 500-ml three-necked flask, 15 g of dried AN94-MAA6 copolymer was added during 30 minutes to 100 ml of dimethylformamide with stirring. The mixture was heated at 70° C. for 15 minutes to give a uniform solution. After cooling the mixture down to room temperature, each 150 ml of the above carbon nanotube dispersion was added thereto followed by evaporating 3600 ml of dimethylformamide therefrom to give a spinning dope.

Spinning: The above spinning dope was extruded at 80° C. from a spinning nozzle where pore diameter was 0.15 mm and pore number was 1 and introduced into a coagulating bath comprising 15 l of methanol cooled at −60° C. via air gap length of 40 mm and the yarn was rolled around a reel. After dipping the yarn into methanol of −60° C. for a whole day and night, it was drawn to an extent of 9-fold. An amino-modified silicone oil was applied thereto followed by drying at 150° C. for 5 minutes to give a precursor fiber where a single yarn fineness was 1.8 dTex. Shape of cross section of this fiber is shown in FIG. 2. As will be apparent from FIG. 2, this precursor fiber has not substantially circular cross section but distorted cross section.

### Referential Example 1A

### An Example without Wetting Treatment

To 1000 ml of water was added 5 g of 3-(N,N-dimethylmyristylammonio) propane sulfonate as amphoteric molecule followed by stirring at room temperature for 5 minutes. To this was added 5 g of double-wall carbon nanotube (grade XO manufactured by Unidym) and dispersed in an aqueous solution of amphoteric molecule together with stirring for about 270 minutes at 40 Hz using a beads mill (Dyno-mill, manufactured in Switzerland, zirconium beads, diameter: 0.65 mm). To this was further added 3 g of polyoxyethylene alkyl lauryl ether sulfonate followed by slowly stirring for about 5 minutes to conduct a stabilizing treatment whereupon a carbon nanotube dispersion was prepared. The above carbon nanotube dispersion (30.7 g), 20 g of an AN94-MAA6 copolymer containing 25% of water and 17.7 ml of water were measured and placed into a 500-ml separable flask equipped with a Logborn blade and stirred to make into a slurry form. Sodium thiocyanate (44.2 g) was added thereto during 2 hours with stirring. After stirring the above for 1 hour at room temperature, 12.2 g of water was evaporated therefrom in vacuo by heating the bath temperature up to 90° C. at the highest to give a spinning dope. Using this, a carbon fiber was obtained in the same manner as in Example 1A. Tensile strength and tensile elastic modulus of the resulting carbon fiber are shown in Table 2. The cross-sectional shape of the precursor fiber was confirmed and found to be substantially circular cross section the same as in Example 1A. In Referential Example 1A, time of about three-fold was needed for dispersing the carbon nanotube as compared with Examples 1A to 15A.

### Referential Example 2A

### An Example without Stabilizing Treatment

To 1000 ml of water was added 5 g of 3-(N,N-dimethylmyristylammonio) propane sulfonate as amphoteric molecule followed by stirring at room temperature for 5 minutes. To this was added 5 g of double-wall carbon nanotube (grade XO manufactured by Unidym) and the mixture was subjected to a wetting treatment at 130° C. and 1.5 atmospheres for about 2 hours using an autoclave (HICLAVE HG-50 manufactured by Hirayama). After cooling down to room temperature, the above was stirred for about 90 minutes at 40 Hz using a beads mill (Dyno-mill, manufactured in Switzerland, zirconium beads, diameter: 0.65 mm) whereupon carbon nanotube was dispersed in an aqueous solution of amphoteric molecule to prepare a carbon nanotube dispersion. No stabilizing treatment was carried out. When this dispersion was allowed to stand for two weeks, aggregation of carbon nanotube took place and black solid appeared on the bottom of the container. Incidentally, in the carbon nanotube dispersion which was prepared by subjecting to a stabilizing treatment as in the cases of Examples 1A to 15A, no aggregation of the carbon nanotube was noted even when being allowed to stand for two weeks.

TABLE 1
Composition of the spinning dope (% by weight)

| | | | Polyacry- | | |
|---|---|---|---|---|---|
| | Amphoteric | | lonitrile | | Carbon |
| | molecule | Stabilizer | polymer | Rhodanate | nanotube |
| Example | 0.15 | 0.09 | 14.9 | 44.0 | 0.15 |
| 1A | | | | | |
| Example | 0.15 | 0.09 | 14.9 | 44.0 | 0.15 |
| 2A | | | | | |
| Example | 0.15 | 0.09 | 14.9 | 44.0 | 0.15 |
| 3A | | | | | |
| Example | 0.15 | 0.09 | 14.9 | 44.0 | 0.15 |
| 4A | | | | | |
| Example | 0.15 | 0.09 | 14.9 | 44.0 | 0.15 |
| 5A | | | | | |
| Example | 0.15 | 0.09 | 14.9 | 44.0 | 0.15 |
| 6A | | | | | |
| Example | 0.15 | 0.09 | 14.9 | 44.0 | 0.15 |
| 7A | | | | | |
| Example | 0.15 | 0.09 | 14.9 | 44.0 | 0.15 |
| 8A | | | | | |
| Example | 0.15 | 0.09 | 14.9 | 44.0 | 0.03 |
| 9A | | | | | |
| Example | 0.15 | 0.09 | 14.9 | 44.0 | 0.15 |
| 10A | | | | | |
| Example | 0.15 | 0.09 | 14.9 | 44.0 | 0.15 |
| 11A | | | | | |
| Example | 0.15 | 0.05 | 15.0 | 44.0 | 0.16 |
| 12A | | | | | |
| Example | 0.15 | 0.05 | 15.0 | 44.0 | 0.16 |
| 13A | | | | | |
| Example | 0.15 | 0.05 | 15.0 | 44.0 | 0.16 |
| 14A | | | | | |
| Example | 0.15 | 0.09 | 14.9 | 44.0 | 0.15 |
| 15A | | | | | |

TABLE 2
Cross-sectional shape of precursor fiber and physical properties of carbon fiber

| | Example 1A | Example 2A | Example 3A | Example 4A | Example 5A | Example 6A | Example 7A | Example 8A | Example 9A |
|---|---|---|---|---|---|---|---|---|---|
| Carbon nanotube | present | present | present | present | present | present | present | present | present |
| Solvent for the | Aqueous | Aqueous | Aqueous | Aqueous | Aqueous | Aqueous | Aqueous | Aqueous | Aqueous |
| spinning dope | solution of | solution of | solution of | solution of | solution of | solution of | solution of | solution of | solution of |
| | rhodanate | rhodanate | rhodanate | rhodanate | rhodanate | rhodanate | rhodanate | rhodanate | rhodanate |
| Amphoteric | present | present | present | present | present | present | present | present | present |
| molecule | | | | | | | | | |
| (dispersing agent) | | | | | | | | | |
| Cross-sectional | Substantially | Substantially | Substantially | Substantially | Substantially | Substantially | Substantially | Substantially | Substantially |
| shape of | circular | circular | circular | circular | circular | circular | circular | circular | circular |
| precursor fiber | shape | shape | shape | shape | shape | shape | shape | shape | shape |
| Tensile strength | ∘∘ | ∘∘ | ∘∘ | ∘∘ | ∘∘ | ∘∘ | ∘∘ | ∘∘ | ∘∘ |
| of carbon fiber | | | | | | | | | |
| Tensile elastic | ∘∘ | ∘∘ | ∘∘ | ∘∘ | ∘∘ | ∘ | ∘ | ∘ | ∘ |
| modulus of | | | | | | | | | |
| carbon fiber | | | | | | | | | |
| | Example | Example | Example | Example | Example | Example | Comparative | Comparative | Referential |
| | 10A | 11A | 12A | 13A | 14A | 15A | Example 1A | Example 2A | Example 1A |
| Carbon nanotube | present | present | present | present | present | present | absent | present | present |
| Solvent for the | Aqueous | Aqueous | Aqueous | Aqueous | Aqueous | Aqueous | Aqueous | DMF | Aqueous |
| spinning dope | solution of | solution of | solution of | solution of | solution of | solution of | solution of | | solution of |
| | rhodanate | rhodanate | rhodanate | rhodanate | rhodanate | rhodanate | rhodanate | | rhodanate |
| Amphoteric | present | present | present | present | present | present | absent | absent | present |
| molecule | | | | | | | | | |
| (dispersing agent) | | | | | | | | | |
| Cross-sectional | Substantially | Substantially | Substantially | Substantially | Substantially | Substantially | Substantially | Distorted | Substantially |
| shape of | circular | circular | circular | circular | circular | circular | circular | shape | circular |
| precursor fiber | shape | shape | shape | shape | shape | shape | shape | | shape |
| Tensile strength | ∘∘ | ∘∘ | ∘∘ | ∘∘ | ∘∘ | ∘∘ | ∘ | x | ∘∘ |
| of carbon fiber | | | | | | | | | |
| Tensile elastic | ∘∘ | ∘∘ | ∘∘ | ∘ | ∘∘ | ∘ | x | ∘ | ∘∘ |
| modulus of | | | | | | | | | |
| carbon fiber | | | | | | | | | |

Tensile strength: ∘∘ for 4.5 GPa or more; ∘ for 3.5 GPa or more; and x for less than 3.5 GPa
Tensile elastic modulus: ∘∘ for 500 GPa or more; ∘ for 400 GPa or more; and x for less than 400 GPa

It will be apparent from Table 2 that, in all of the cases of Examples 1A to 15A and Referential Example 1A where carbon nanotube was added, aqueous solution of rhodanate was used as a solvent for the spinning dope and amphoteric molecule was used as a dispersing agent, there were prepared the carbon fibers having high tensile strength and high tensile elastic modulus. However, in Comparative Example 1A (the conventional common PAN type carbon fiber) where no carbon nanotube was used and no amphoteric molecule was used as well, although the tensile strength was high, the tensile elastic modulus was inferior. Further, in Comparative Example 2A (the carbon fiber of Patent Document 1) where carbon nanotube was used but DMF was used as a solvent for the spinning dope and no amphoteric molecule was used, although the tensile elastic modulus was higher than that in Comparative Example 1A, cross-section of the fiber was distorted whereby the tensile strength was inferior.

### Example 1B

Preparation of spinning dope: To 1000 ml of water was added 5 g of 3-(N, N-dimethylmyristylammonio) propane sulfonate as amphoteric molecule followed by stirring at room temperature for 5 minutes. To this was added 5 g of double-wall carbon nanotube (grade XO manufactured by Unidym) and the mixture was subjected to a wetting treatment at 130° C. and 1.5 atmospheres for about 2 hours using an autoclave (HICLAVE HG-50 manufactured by Hirayama). After cooling down to room temperature, the above was stirred for about 90 minutes at 40 Hz using a beads mill (Dyno-mill, manufactured in Switzerland, zirconium beads, diameter: 0.65 mm) whereupon carbon nanotube was dispersed in an aqueous solution of amphoteric molecule. To this was further added 3 g of polyoxyethylene alkyl lauryl ether sulfonate followed by slowly stirring for about 5 minutes to conduct a stabilizing treatment whereupon a carbon nanotube dispersion was prepared. The above carbon nanotube dispersion (30 g), 20 g of an AN94-MAA6 copolymer containing 25% of water and 19.6 ml of water were measured and stirred to make into a slurry form. Zinc chloride (51 g) was added thereto during 2 hours with stirring. After stirring the above for 1 hour at room temperature, 20.4 g of water was evaporated therefrom in vacuo by heating the bath temperature up to 90° C. at the highest to give a spinning dope. The composition of the resulting spinning dope is shown in Table 3.

Spinning: The above spinning dope was extruded at 80° C. from a spinning nozzle where the pore size was 0.15 mm and the pore numbers were 10, then introduced into a coagulating bath comprising 15 liters of a 15% by weight aqueous solution of zinc chloride at 0° C. via air gap of 5 mm and washed with a 5% by weight aqueous solution of zinc chloride. After that, it was drawn to an extent of two-fold, washed with water and further washed with 0.2% by weight of nitric acid. Then this yarn was further drawn in three-fold in boiling water and an amino-modified silicone oil was applied thereto followed by drying at 150° C. for 5 minutes to give a precursor fiber where a single yarn fineness was 1.3 dTex. The cross-sectional shape of the prepared precursor fiber was confirmed with electron microscope and found to be substantially circular cross section.

Flame-resistance treatment: The above precursor fiber was heated in air for 1 hour each in a constant length at 220° C., 230° C., 240° C. and 250° C. in the first, second, third and fourth stages, respectively to give the yarn of 1.38 specific gravity being subjected to a flame-resistance treatment.

Preliminary carbonization treatment: The above yarn subjected to the flame-resistance treatment was heated in nitrogen stream for 2 minutes in a constant length at 700° C. to give the yarn being subjected to a preliminary carbonization treatment.

Carbonization treatment: The above yarn subjected to the preliminary carbonization treatment was heated in nitrogen stream for 2 minutes in a constant length at 1300° C. to give a carbon fiber. Tensile strength and tensile elastic modulus of the resulting carbon fiber are shown in Table 4.

### Example 2B

The same operation as in Example 1B was conducted using a single-wall carbon nanotube (Hipco manufactured by CNI) instead of the double-wall carbon nanotube to prepare a spinning dope. Composition of the resulting spinning dope is shown in Table 3. This was further stirred for 3 hours using a mixer of a rotation/revolution type to give the final spinning dope. Spinning, preliminary carbonization treatment and carbonization treatment were carried out according to the same manner as in Example 1B to give a carbon fiber. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Example 3B

The same operation as in Example 1B was conducted except for using a multi-wall carbon nanotube (Baytubes manufactured by Bayer MaterialScience AG) instead of the double-wall carbon nanotube in Example 1B to prepare a spinning dope. Composition of the resulting spinning dope is shown in Table 3. Using this spinning dope, a carbon fiber was obtained in the same manner as in Example 1B. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Example 4B

The same operation as in Example 1B was conducted except for using an AN95-MA5 copolymer instead of the AN94-MAA6 copolymer in Example 1B to prepare a spinning dope. Composition of the resulting spinning dope is shown in Table 3. Using this spinning dope, a carbon fiber was obtained in the same manner as in Example 1B. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Example 5B

The same operation as in Example 3B was conducted except for using an AN95-MAA4-IA1 copolymer instead of the AN94-MAA6 copolymer in Example 3B to prepare a spinning dope. Composition of the resulting spinning dope is shown in Table 3. Using this spinning dope, a carbon fiber was obtained in the same manner as in Example 3B. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Example 6B

The same operation as in Example 1B was conducted except for using a PAN instead of the AN94-MAA6 copolymer in Example 1B to prepare a spinning dope. Composition of the resulting spinning dope is shown in Table 3. Using this spinning dope, a carbon fiber was obtained in the same manner as in Example 1B. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Example 7B

The same operation as in Example 6B was conducted except for preparing a spinning dope by using a single-wall carbon nanotube instead of the double-wall carbon nanotube in Example 6B and stirring for 3 hours using a mixer of a rotation/revolution type as in Example 2B to prepare a spinning dope. Composition of the resulting spinning dope is shown in Table 3. Using this spinning dope, a carbon fiber was obtained in the same manner as in Example 6B. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Example 8B

The same operation as in Example 4B was conducted except for using a multi-wall carbon nanotube instead of the double-wall carbon nanotube in Example 4B to prepare a spinning dope. Composition of the resulting spinning dope is shown in Table 3. Using this spinning dope, a carbon fiber was obtained in the same manner as in Example 4B. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Example 9B

The same operation as in Example 1B was conducted except for using 1.0 g of double-wall carbon nanotube in Example 1B to prepare a spinning dope. Composition of the resulting spinning dope is shown in Table 3. Using this spinning dope, a carbon fiber was obtained in the same manner as in Example 1B. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Example 10B

The same operation as in Example 3B was conducted except for using 5 g of 3-(N,N-dimethylstearylammonio)propane sulfonate as an amphoteric molecule in Example 3B to prepare a spinning dope. Composition of the resulting spinning dope is shown in Table 3. Using this spinning dope, a carbon fiber was obtained in the same manner as in Example 3B. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Example 11B

The same operation as in Example 1B was conducted except for using 5 g of 3-[(3-cholamidopropyl)dimethylammonio]-1-propane sulfonate as an amphoteric molecule in Example 1B to prepare a spinning dope. Composition of the resulting spinning dope is shown in Table 3. Using this spinning dope, a carbon fiber was obtained in the same manner as in Example 1B. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Example 12B

To 37.2 ml of water was added 3 g of 3-(N,N-dimethylmyristylammonio)propane sulfonate as amphoteric molecule followed by stirring at room temperature for 5 minutes. To this was added 3 g of multi-wall carbon nanotube (Baytubes manufactured by Bayer MaterialScience AG) and the mixture was subjected to a wetting treatment at 130° C. and 1.5 atmospheres for about 2 hours in an autoclave. After cooling down to room temperature, the above was stirred for about 90 minutes at 40 Hz using a beads mill whereupon carbon nanotube was dispersed in an aqueous solution of amphoteric molecule. To this was further added 1 g of polyoxyethylene alkyl lauryl ether sulfonate followed by slowly stirring for about 5 minutes to conduct a stabilizing treatment. To this was added 55.8 g of zinc chloride followed by stirring to dissolve whereupon a carbon nanotube dispersion was prepared. The above carbon nanotube dispersion (5 g), 20 g of an AN94-MAA6 copolymer containing 25% of water and 44.6 g of water were measured and placed into a 500-ml eggplant type flask followed by stirring to make into a slurry form. After it was stirred for 2 hours at room temperature, 20.4 g of water was evaporated therefrom using an evaporator to give a spinning dope. Composition of the resulting spinning dope is shown in Table 3. Using this spinning dope, a carbon fiber was obtained in the same manner as in Example 1B. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Example 13B

An AN94-MAA6 copolymer (15 g), 49.55 ml of water and 51 g of zinc chloride were measured and placed into a 500-ml eggplant type flask, stirred at 60 to 80° C. for 10 minutes and gradually cooled down to room temperature to give a polymer solution. To this was added 5 g of the carbon nanotube dispersion prepared in Example 12B, the mixture was stirred at room temperature for 2 hours and 20.4 g of water was evaporated therefrom using an evaporator to give a spinning dope. Composition of the resulting spinning dope is shown in Table 3. Using this spinning dope, a carbon fiber was obtained in the same manner as in Example 1B. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Example 14B

To 93 ml of water was added 3 g of 3-(N,N-dimethylmyristylammonio)propane sulfonate as amphoteric molecule followed by stirring at room temperature for 5 minutes. To this was added 3 g of multi-wall carbon nanotube (Baytubes manufactured by Bayer MaterialScience AG) and the mixture was subjected to a wetting treatment at 130° C. and 1.5 atmospheres for about 2 hours in an autoclave. After cooling down to room temperature, the above was stirred for about 90 minutes at 40 Hz using a beads mill whereupon carbon nanotube was dispersed in an aqueous solution of amphoteric molecule. To this was further added 1 g of polyoxyethylene alkyl lauryl ether sulfonate followed by slowly stirring for about 5 minutes to conduct a stabilizing treatment whereupon a multi-wall carbon nanotube dispersion was prepared. On the other hand, 15 g of an AN94-MAA6 copolymer, 29.15 ml of water and 51 g of zinc chloride were measured and placed into a 500-ml eggplant type flask followed by stirring to give a suspension. To this suspension was added 5 g of the above carbon nanotube dispersion and the mixture was stirred at 80° C. for 10 minutes and gradually cooled down to room temperature to give a spinning dope. Composition of the resulting spinning dope is shown in Table 3. Using this spinning dope, a carbon fiber was obtained in the same manner as in Example 1B. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Comparative Example 1B

Water (39.2 ml) and 20 g of an AN94-MAA6 copolymer containing 25% of water were measured and placed into a 500-ml eggplant type flask and the mixture was stirred to make into a slurry form. Zinc chloride (44.2 g) was added thereto with stirring during 2 hours. After the mixture was stirred for 1 hour at room temperature, it was heated up to 60° C. to give a uniform spinning dope. Using this spinning dope, a carbon fiber was obtained in the same manner as in Example 1B. Tensile strength and tensile elastic modulus of the resulting carbon fiber are shown in Table 4. The cross-sectional shape of the precursor fiber was confirmed with electron microscope and found to be substantially circular cross section the same as in Example 1B.

### Referential Example 1B

### An Example without Wetting Treatment

To 1000 ml of water was added 5 g of 3-(N,N-dimethylmyristylammonio)propane sulfonate as amphoteric molecule followed by stirring at room temperature for 5 minutes. To this was added 5 g of double-wall carbon nanotube (grade XO manufactured by Unidym) and dispersed in an aqueous solution of amphoteric molecule together with stirring for about 270 minutes at 40 Hz using a beads mill (Dyno-mill, manufactured in Switzerland, zirconium beads, diameter: 0.65 mm). To this was further added 3 g of polyoxyethylene alkyl lauryl ether sulfonate followed by slowly stirring for about 5 minutes to conduct a stabilizing treatment whereupon a carbon nanotube dispersion was prepared. The above carbon nanotube dispersion (30.7 g), 20 g of an AN94-MAA6 copolymer containing 25% of water and 19.55 ml of water were measured and stirred to make into a slurry form. Zinc chloride (51 g) was added thereto during 2 hours with stirring. After stirring the above for 1 hour at room temperature, 20.4 g of water was evaporated therefrom in vacuo by heating the bath temperature up to 90° C. at the highest to give a spinning dope. Using this, a carbon fiber was obtained in the same manner as in Example 1B. Tensile strength and tensile elastic modulus of the resulting carbon fiber are shown in Table 4. The cross-sectional shape of the precursor fiber was confirmed with electron microscope and found to be substantially circular cross section the same as in Example 1B. In Referential Example 1B, time of about three-fold was needed for dispersing the carbon nanotube as compared with Examples 1B to 14B.

### Referential Example 2

### An Example without Stabilizing Treatment

To 1000 ml of water was added 5 g of 3-(N,N-dimethylmyristylammonio)propane sulfonate as amphoteric molecule followed by stirring at room temperature for 5 minutes. To this was added 5 g of double-wall carbon nanotube (grade XO manufactured by Unidym) and the mixture was subjected to a wetting treatment at 130° C. and 1.5 atmospheres for about 2 hours using an autoclave (HICLAVE HG-50 manufactured by Hirayama). After cooling down to room temperature, the above was stirred for about 90 minutes at 40 Hz using a beads mill (Dyno-mill, manufactured in Switzerland, zirconium beads, diameter: 0.65 mm) whereupon carbon nanotube was dispersed in an aqueous solution of amphoteric molecule to prepare a carbon nanotube dispersion. No stabilizing treatment was carried out. When this dispersion was allowed to stand for two weeks, aggregation of carbon nanotube took place and black solid appeared on the bottom of the container. Incidentally, in the carbon nanotube dispersion which was prepared by subjecting to a stabilizing treatment as in the cases of Examples 1B to 14B, no aggregation of the carbon nanotube was noted even when being allowed to stand for two weeks.

TABLE 3
Composition of the spinning dope (% by weight)

| | Amphoteric | Stabi- | Polyacrylonitrile | Zinc | Carbon |
|---|---|---|---|---|---|
| | molecule | lizer | polymer | chloride | nanotube |
| Example | 0.15 | 0.09 | 14.9 | 60.0 | 0.15 |
| 1B | | | | | |
| Example | 0.15 | 0.09 | 14.9 | 60.0 | 0.15 |
| 2B | | | | | |
| Example | 0.15 | 0.09 | 14.9 | 60.0 | 0.15 |
| 3B | | | | | |
| Example | 0.15 | 0.09 | 14.9 | 60.0 | 0.15 |
| 4B | | | | | |
| Example | 0.15 | 0.09 | 14.9 | 60.0 | 0.15 |
| 5B | | | | | |
| Example | 0.15 | 0.09 | 14.9 | 60.0 | 0.15 |
| 6B | | | | | |
| Example | 0.15 | 0.09 | 14.9 | 60.0 | 0.15 |
| 7B | | | | | |
| Example | 0.15 | 0.09 | 14.9 | 60.0 | 0.15 |
| 8B | | | | | |
| Example | 0.15 | 0.09 | 14.9 | 60.0 | 0.03 |
| 9B | | | | | |
| Example | 0.15 | 0.09 | 14.9 | 60.0 | 0.15 |
| 10B | | | | | |
| Example | 0.15 | 0.09 | 14.9 | 60.0 | 0.15 |
| 11B | | | | | |
| Example | 0.15 | 0.05 | 15.0 | 60.0 | 0.16 |
| 12B | | | | | |
| Example | 0.15 | 0.05 | 15.0 | 60.0 | 0.16 |
| 13B | | | | | |
| Example | 0.15 | 0.05 | 15.0 | 60.0 | 0.16 |
| 14B | | | | | |

TABLE 4
Cross-sectional shape of precursor fiber and physical properties of carbon fiber

| | Example 1B | Example 2B | Example 3B | Example 4B | Example 5B | Example 6B | Example 7B | Example 8B |
|---|---|---|---|---|---|---|---|---|
| Carbon nanotube | present | present | present | present | present | present | present | present |
| Solvent for the | Aqueous | Aqueous | Aqueous | Aqueous | Aqueous | Aqueous | Aqueous | Aqueous |
| spinning dope | solution of | solution of | solution of | solution of | solution of | solution of | solution of | solution of |
| | zinc chloride | zinc chloride | zinc chloride | zinc chloride | zinc chloride | zinc chloride | zinc chloride | zinc chloride |
| Amphoteric | present | present | present | present | present | present | present | present |
| molecule | | | | | | | | |
| (dispersing agent) | | | | | | | | |
| Cross-sectional | Substantially | Substantially | Substantially | Substantially | Substantially | Substantially | Substantially | Substantially |
| shape of | circular | circular | circular | circular | circular | circular | circular | circular |
| precursor fiber | shape | shape | shape | shape | shape | shape | shape | shape |
| Tensile strength | ∘∘ | ∘∘ | ∘∘ | ∘∘ | ∘∘ | ∘∘ | ∘∘ | ∘∘ |
| of carbon fiber | | | | | | | | |
| Tensile elastic | ∘∘ | ∘∘ | ∘∘ | ∘∘ | ∘∘ | ∘ | ∘ | ∘ |
| modulus of | | | | | | | | |
| carbon fiber | | | | | | | | |
| | | | | | | | Comparative | Referential |
| | Example 9B | Example 10B | Example 11B | Example 12B | Example 13B | Example 14B | Example 1B | Example 1B |
| Carbon nanotube | present | present | present | present | present | present | absent | present |
| Solvent for the | Aqueous | Aqueous | Aqueous | Aqueous | Aqueous | Aqueous | Aqueous | Aqueous |
| spinning dope | solution of | solution of | solution of | solution of | solution of | solution of | solution of | solution of |
| | zinc chloride | zinc chloride | zinc chloride | zinc chloride | zinc chloride | zinc chloride | zinc chloride | zinc chloride |
| Amphoteric | present | present | present | present | present | present | absent | present |
| molecule | | | | | | | | |
| (dispersing agent) | | | | | | | | |
| Cross-sectional | Substantially | Substantially | Substantially | Substantially | Substantially | Substantially | Substantially | Substantially |
| shape of | circular | circular | circular | circular | circular | circular | circular | circular |
| precursor fiber | shape | shape | shape | shape | shape | shape | shape | shape |
| Tensile strength | ∘∘ | ∘∘ | ∘∘ | ∘∘ | ∘∘ | ∘∘ | ∘ | ∘∘ |
| of carbon fiber | | | | | | | | |
| Tensile elastic | ∘ | ∘∘ | ∘∘ | ∘∘ | ∘ | ∘∘ | x | ∘∘ |
| modulus of | | | | | | | | |
| carbon fiber | | | | | | | | |

Tensile strength: ∘∘ for 4.5 GPa or more; ∘ for 3.5 GPa or more; and x for less than 3.5 GPa
Tensile elastic modulus: ∘∘ for 500 GPa or more; ∘ for 400 GPa or more; and x for less than 400 G

It will be apparent from Table 4 that, in all of the cases of Examples 1B to 14B and Referential Example 1B where carbon nanotube was added, aqueous solution of zinc chloride was used as a solvent for the spinning dope and amphoteric molecule was used as a dispersing agent, there were prepared the carbon fibers having high tensile strength and high tensile elastic modulus. However, in Comparative Example 1B (the conventional common PAN type carbon fiber) where no carbon nanotube was used and no amphoteric molecule was used as well, although the tensile strength was high, the tensile elastic modulus was inferior. Further, in Comparative Example 2A (the carbon fiber of Patent Document 1) where carbon nanotube was used but DMF was used as a solvent for the spinning dope and no amphoteric molecule was used, although the tensile elastic modulus was higher than that in Comparative Example 1B, cross-section of the fiber was distorted whereby the tensile strength was inferior.

### INDUSTRIAL APPLICABILITY

When the precursor fiber obtained by the production process of the present invention is used, it is now possible to prepare a carbon fiber having both high tensile strength and high tensile elastic modulus. The carbon fiber as such is quite useful as a material for aircrafts and a material for spacecrafts.

1. A process for the production of a precursor fiber for carbon fiber, which is characterized in comprising the following steps (1) to (5):
(1) a step where an aqueous solution of amphoteric molecule is prepared;
(2) a step where carbon nanotube is added to the aqueous solution of the amphoteric molecule so that the carbon nanotube is dispersed therein to prepare a dispersion of carbon nanotube;
(3) a step where the carbon nanotube dispersion is mixed with a polyacrylonitrile polymer and rhodanate or zinc chloride to prepare a spinning dope;
(4) a step where a coagulated yarn is prepared from the spinning dope by a wet or dry-wet spinning method; and
(5) a step where the coagulated yarn is drawn to give a precursor fiber for carbon fiber.

2. The process according to claim 1, which is characterized in that the spinning dope prepared in the step (3) contains 30 to 60% by weight of rhodanate, 5 to 30% by weight of polyacrylonitrile polymer, 0.01 to 5% by weight of carbon nanotube to the polyacrylonitrile polymer, and 0.01 to 5.0% by weight of amphoteric molecule.

3. The process according to claim 1, which is characterized in that the spinning dope prepared in the step (3) contains 30 to 70% by weight of zinc chloride, 5 to 30% by weight of polyacrylonitrile polymer, 0.01 to 5% by weight of carbon nanotube to the polyacrylonitrile polymer, and 0.01 to 5.0% by weight of amphoteric molecule.

4. The process according to claim 1, which is characterized in that, before carbon nanotube is dispersed in the step (2), a wetting treatment is carried out.

5. The process according to claim 1, which is characterized in that, the carbon nanotube dispersion is subjected to a stabilization treatment in the step (2).

6. A precursor fiber for carbon fiber produced by the process according to claim 1, which is characterized in having substantially circular cross section and containing carbon nanotube.

7. A precursor fiber for carbon fiber, which is characterized in having substantially circular cross section and containing carbon nanotube and amphoteric molecule.

8. A carbon fiber, which is characterized in being produced by subjecting the precursor fiber for carbon fiber according to claim 6 to flame-resistance treatment, preliminarily carbonization treatment, and carbonization treatment.

9. A spinning dope, which is characterized in comprising an aqueous solution containing rhodanate or zinc chloride, polyacrylonitrile polymer, carbon nanotube and amphoteric molecule.

10. A precursor fiber for carbon fiber produced by the process according to claim 2, which is characterized in having substantially circular cross section and containing carbon nanotube.

11. A precursor fiber for carbon fiber produced by the process according to claim 3, which is characterized in having substantially circular cross section and containing carbon nanotube.

12. A precursor fiber for carbon fiber produced by the process according to claim 4, which is characterized in having substantially circular cross section and containing carbon nanotube.

13. A precursor fiber for carbon fiber produced by the process according to claim 5, which is characterized in having substantially circular cross section and containing carbon nanotube.

14. A carbon fiber, which is characterized in being produced by subjecting the precursor fiber for carbon fiber according to claim 10 to flame-resistance treatment, preliminarily carbonization treatment, and carbonization treatment.

15. A carbon fiber, which is characterized in being produced by subjecting the precursor fiber for carbon fiber according to claim 11 to flame-resistance treatment, preliminarily carbonization treatment, and carbonization treatment.

16. A carbon fiber, which is characterized in being produced by subjecting the precursor fiber for carbon fiber according to claim 12 to flame-resistance treatment, preliminarily carbonization treatment, and carbonization treatment.

17. A carbon fiber, which is characterized in being produced by subjecting the precursor fiber for carbon fiber according to claim 13 to flame-resistance treatment, preliminarily carbonization treatment, and carbonization treatment.

18. A carbon fiber, which is characterized in being produced by subjecting the precursor fiber for carbon fiber according to claim 7 to flame-resistance treatment, preliminarily carbonization treatment, and carbonization treatment.
